(19) United States
(12) Patent Application Publication
(10) Pub. No.: US 2022/0385218 A1
(43) Pub. Date: Dec. 1, 2022

(54) SENSORLESS MOTOR ROTOR ANGLE CORRECTION METHOD AND SYSTEM

(71) Applicant: Chicony Power Technology Co., Ltd., New Taipei City (TW)

(72) Inventor: Chung-Wei Huang, New Taipei City (TW)

(21) Appl. No.: 17/305,692

(22) Filed: Jul. 13, 2021

(30) Foreign Application Priority Data
Jun. 1, 2021 (TW) 110119897

(51) Int. Cl. H02P 21/18; H02P 21/22

(52) U.S. Cl. CPC H02P 21/18; H02P 21/22

(57) ABSTRACT

A sensorless motor rotor angle correction method includes: outputting a direct-axis pulse voltage to generate a direct-axis current and a quadrature-axis current; determining whether an angle difference is zero; outputting a positive direct-axis excitation voltage when the angle difference is zero, and recording an excitation time required to reach a predetermined positive current value; outputting a negative direct-axis excitation voltage, so that the direct-axis current returns to an initial current value; outputting a negative direct-axis excitation voltage for the excitation time to obtain a maximum negative current value; outputting a positive excitation voltage, so that the direct-axis current returns to the initial current value; correcting an orientation of a synchronous rotation coordinate axis if the maximum negative current value is greater than the predetermined positive current value.

### CROSS-REFERENCE TO RELATED APPLICATION

This non-provisional application claims priority under 35 U.S.C. § 119(a) to Patent Application No. 110119897 in Taiwan, R.O.C. on Jun. 1, 2021, the entire contents of which are hereby incorporated by reference.

### BACKGROUND

### Technical Field

The instant disclosure relates to a motor control method and system, and in particular, to a motor rotor angle correction method and system.

### Related Art

A permanent magnet synchronous motor includes a rotor and stator. The permanent magnet synchronous motor generates a rotating magnetic field by using the stator to rotate the rotor, thereby generating a motor torque. In order to control the permanent magnet synchronous motor desirably, it is necessary to detect relative positions of the rotor and the stator at any time and ensure that the rotor and the stator are synchronous.

Generally, the relative positions of the rotor and the stator of the permanent magnet synchronous motor are measured by using a back electromotive force generated by means of the rotation of the rotor or by using a sensor mounted in the permanent magnet motor. However, the back electromotive force is small when the rotor is rotated at a low speed. Therefore, additional energy is required to cause the rotor to brake so as to control the motor stably. Mounting the sensor in the permanent magnet synchronous motor increases costs.

### SUMMARY

In view of the above, in an embodiment, a sensorless motor rotor angle correction method is provided. The method includes a voltage output step, a position determination step, a positive excitation step, a positive de-excitation step, a negative excitation step, a negative de-excitation step, and a magnetic pole correction step. a voltage output step including outputting a direct-axis pulse voltage to a stator of a motor, so that a direct axis of a synchronous rotation coordinate axis of the stator generates a direct-axis current, and a quadrature axis of the synchronous rotation coordinate axis generates a quadrature-axis current; a position determination step including determining whether an angle difference between the direct axis and a magnetic pole direction of a rotor is zero; a positive excitation step including outputting a positive direct-axis excitation voltage to the stator when the angle difference is zero, and stopping outputting the positive direct-axis excitation voltage and recording an excitation time, when the direct-axis current reaches a predetermined positive current value from an initial current value; a positive de-excitation step including outputting a negative direct-axis excitation voltage to the stator, so that the direct-axis current returns to the initial current value from the predetermined positive current value; a negative excitation step including stopping outputting the negative direct-axis excitation voltage and obtaining a maximum negative current value, when the negative direct-axis excitation voltage is outputted to the stator for the excitation time; a negative de-excitation step including outputting the positive direct-axis excitation voltage to the stator, so that the direct-axis current returns to the initial current value from the maximum negative current value; and a magnetic pole correction step including correcting an orientation of the synchronous rotation coordinate axis if the maximum negative current value is greater than the predetermined positive current value, so that the direct axis is oriented toward a north pole of the magnetic pole direction.

In another embodiment, a sensorless motor rotor angle correction system is provided. The system includes a motor, a storage module, a voltage output module, an error calculation module, an excitation module, a voltage adjustment module, and a control module. The motor includes a stator and a rotor. The stator has a synchronous rotation coordinate axis. The synchronous rotation coordinate axis has a direct axis and a quadrature axis. The rotor has a magnetic pole direction. The storage module is configured to store a predetermined positive current value. The voltage output module is configured to output a direct-axis pulse voltage to the stator, so that the direct axis generates a direct-axis current and the quadrature axis generates a quadrature-axis current. The error calculation module is configured to calculate an angle difference between the direct axis and the magnetic pole direction. The excitation module is configured to output a positive direct-axis excitation voltage or a negative direct-axis excitation voltage to the stator. The control module is electrically connected to the motor, the storage module, the voltage output module, the error calculation module, the excitation module, and the voltage adjustment module. The control module is configured to be successively switched to a positive excitation mode, a positive de-excitation mode, a negative excitation mode, a negative de-excitation mode, and a magnetic pole correction mode when the angle difference is zero, In the positive excitation mode, the control module controls the excitation module to output the positive direct-axis excitation voltage, and when the direct-axis current reaches the predetermined positive current value from an initial current value, the control module controls the excitation module to stop outputting the positive direct-axis excitation voltage and controls the storage module to store an excitation time. In the positive de-excitation mode, the control module controls the excitation module to output the negative direct-axis excitation voltage to the stator, so that the direct-axis current returns to the initial current value from the predetermined positive current value. In the negative excitation mode, when the control module controls the excitation module to output the negative direct-axis excitation voltage to the stator for the excitation time, the control module controls the excitation module to stop outputting the negative direct-axis excitation voltage, and obtains a maximum negative current value and controls the storage module to store the maximum negative current value. In the negative de-excitation mode, the control module controls the excitation module to output the positive direct-axis excitation voltage to the stator, so that the direct-axis current returns to the initial current value from the maximum negative current value. In the magnetic pole correction mode, when the control module determines that the maximum negative current value is greater than the predetermined positive current value, the voltage adjustment module corrects an orientation of the synchronous rotation coordinate axis, so that the direct axis is oriented toward a north pole of the magnetic pole direction.

According to the sensorless motor rotor angle correction method and system in the embodiments of the instant disclosure, the direct-axis pulse voltage is outputted to the stator of the motor, so that the direct axis of the synchronous rotation coordinate axis of the stator generates the direct-axis current and the quadrature axis generates the quadrature-axis current, and when the angle difference between the direct axis and the magnetic pole direction of the rotor is zero, the positive excitation step, the positive de-excitation step, the negative excitation step, the negative de-excitation step, and the magnetic pole correction step are performed, to avoid a wrong orientation of the direct axis of the synchronous rotation coordinate axis, so that relative positions of the rotor and the stator of the motor can be detected and corrected at any time at any speed without a need to mount a sensor on the motor, thereby ensuring that the rotor and the stator are synchronous.

### BRIEF DESCRIPTION OF THE DRAWINGS

FIG. 1 is a system architecture diagram of a sensorless motor rotor angle correction system according to an embodiment of the instant disclosure.

FIG. 2 is a cross-sectional view of relative positions of a rotor and a stator according to an embodiment of the instant disclosure.

FIG. 3 is a schematic diagram of signal transmission between a pulse power calculation module and an error calculation module according to an embodiment of the instant disclosure.

FIG. 4 is a flowchart of steps of a sensorless motor rotor angle correction method according to an embodiment of the instant disclosure.

FIG. 5 is a schematic diagram of a direct-axis direct current according to an embodiment of the instant disclosure.

FIG. 6 is a cross-sectional view of other relative positions of the rotor and the stator according to an embodiment of the instant disclosure.

FIG. 7 is a cross-sectional view of still other relative positions of the rotor and the stator according to an embodiment of the instant disclosure.

FIG. 8A is a partial flowchart of steps of a sensorless motor rotor angle correction method according to another embodiment of the instant disclosure.

FIG. 8B is another partial flowchart of the steps of the sensorless motor rotor angle correction method according to an embodiment of the instant disclosure.

### DETAILED DESCRIPTION

The term “module” used in the following description means an application specific integrated circuit (ASIC), an electronic circuit, a microprocessor, or a chip or a circuit executing one or more software or firmware programs. A module is configured to perform various algorithms, transformations and/or logic processing to generate one or more signals. When the module is implemented by using software, the module may serve as a program readable by the chip or the circuit design to be implemented in a memory through program execution.

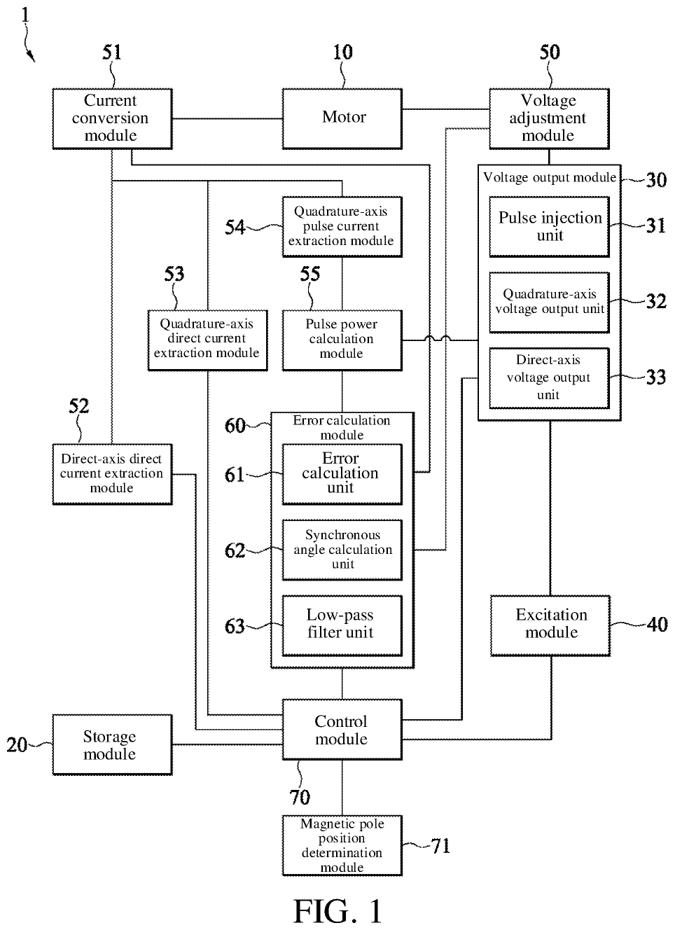

FIG. 1 is a system architecture diagram of a sensorless motor rotor angle correction system according to an embodiment of the instant disclosure. As shown in FIG. 1, a sensorless motor rotor angle correction system 1 in this embodiment of the instant disclosure includes a motor 10, a storage module 20, a voltage output module 30, an error calculation module 60, an excitation module 40, a voltage adjustment module 50, and a control module 70.

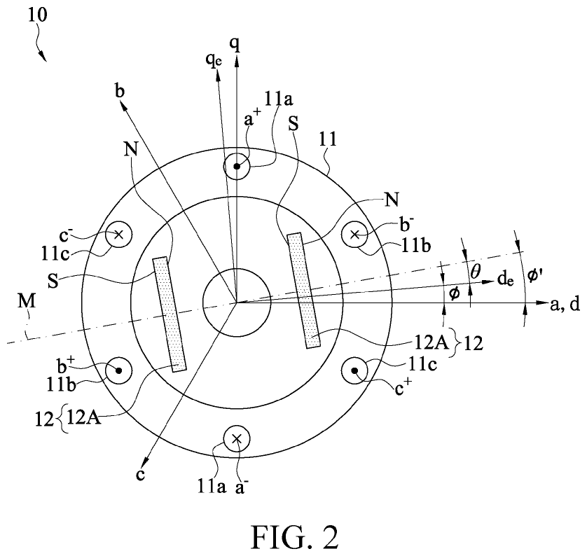

FIG. 2 is a cross-sectional view of relative positions of a rotor and a stator according to an embodiment of the instant disclosure. As shown in FIG. 1 and FIG. 2, the motor 10 includes a stator 11 and a rotor 12. In some embodiments, the motor 10 may be a permanent magnet synchronous motor. The permanent magnet synchronous motor may be a built-in permanent magnet motor or a surface permanent magnet motor. The rotor 12 may include permanent magnets 12A or other magnetic materials such as materials containing iron, cobalt, or nickel. In this embodiment, the rotor 12 includes two permanent magnets 12A each having a magnetic pole direction M. The magnetic pole direction M has a south pole S and a north pole N opposite to each other. The two permanent magnets 12A are disposed side by side, so that respective magnetic pole directions M are collinear.

As shown in FIG. 2, the stator 11 includes a synchronous rotation coordinate axis. The synchronous rotation coordinate axis has a direct axis de and a quadrature axis qe. Specifically, in this embodiment, the stator 11 includes a coil 11a, a coil 11b, and a coil 11c. A current of the coil 11a flows into a cross section of the stator 11 in a current direction a− and then out of the cross section of the stator 11 in a current direction a+ to form a phasor a. A current of the coil 11b flows into the cross section of the stator 11 in a current direction b− and then out of the cross section of the stator 11 in a current direction b+ to form a phasor b. A current of the coil 11c flows into the cross section of the stator 11 in a current direction c− and then out of the cross section of the stator 11 in a current direction c+ to form a phasor c. The coil 11a, the coil 11b, and the coil 11c differ from each other by 120 degrees two by two. A magnetic field formed by means of interaction among the coils 11a, 11b, and 11c is defined by a three-phase static coordinate axis formed by the phasors a, b, and c.

As shown in FIG. 2, by performing a Clarke's transformation on the three-phase static coordinate axis formed by the coils 11a, 11b, and 11c, a two-phase static coordinate axis can be obtained, and by performing a Park's transformation on the two-phase static coordinate axis, the foregoing synchronous rotation coordinate axis of the stator 11 can be obtained.

As shown in FIG. 2, the two-phase static coordinate axis has a d axis and a q axis. The two-phase static coordinate axis defines a phase of the stator 11, that is, a phase of a rotating magnetic field generated by the stator 11. For example, as shown in FIG. 2, the d axis is an initial direction of the rotating magnetic field of the stator 11. In this embodiment, a phase of the stator 11 in an initial state is zero.

As shown in FIG. 2, a phase of the rotor 12 estimated by means of the Park's transformation is defined by the synchronous rotation coordinate axis. Specifically, the direct axis de of the synchronous rotation coordinate axis is a magnetic pole direction M of the rotor 12 estimated by means of the Park's transformation. In this embodiment, the direct axis de and the d axis are at a synchronous angle ϕ to each other. The synchronous angle ϕ is the estimated phase of the rotor 12. Therefore, in order to synchronize a phase of the stator 11 to the estimated phase of the rotor 12, the phase of the stator 11 needs to be adjusted to the phase of the rotor 12 from the initial state.

Since the foregoing synchronous rotation coordinate axis is obtained by means of estimation, the direct axis de is unnecessarily the same as the foregoing actual magnetic pole direction M. For example, as shown in FIG. 2, in this embodiment, an angle difference θ is formed between the direct axis de and the magnetic pole direction M. As shown in FIG. 1 and FIG. 2, the sensorless motor rotor angle correction system 1 is configured to correct the direct axis de of the synchronous rotation coordinate axis to the north pole N of the actual magnetic pole direction M of the rotor 12.

As shown in FIG. 1, the storage module 20 is, for example, any type of fixed or removable random access memory (RAM), read-only memory (ROM), or flash memory. The storage module 20 may store a current value and a time, for example, an excitation time required to excite the motor 10. The storage module 20 pre-stores a predetermined positive current value. The predetermined positive current value may be greater than 50% of a rated current value of the motor 10. For example, the predetermined positive current value may be 60%, 70%, or 80% of the rated current value of the motor 10.

As shown in FIG. 1, in this embodiment, the voltage output module 30 includes a pulse injection unit 31, a quadrature-axis voltage output unit 32, and a direct-axis voltage output unit 33. The pulse injection unit 31 may be, for example, a pulse generator, a signal generator, or a motor pulse generator. The pulse injection unit 31 may output a pulse voltage with a fixed frequency and a fixed amplitude. A waveform of the pulse voltage may be a sine wave, a triangular wave, a square wave, or a trapezoidal wave. The frequency of the pulse voltage may be more than five times a rated frequency of the motor. For example, the frequency of the pulse voltage is six, eight, or ten times the rated frequency of the motor. The frequency of the pulse voltage may be converted to an angular velocity of the pulse voltage by multiplying a double of the pi. The amplitude of the pulse voltage may be 15% of a rated current of the motor multiplied by a reactance. The direct-axis voltage output unit 33 and the quadrature-axis voltage output unit 32 may be the voltage generators, for example. The direct-axis voltage output unit 33 is configured to receive the pulse voltage and convert the pulse voltage to a direct-axis pulse voltage, and the quadrature-axis voltage output unit 32 may output a zero voltage to define a quadrature-axis voltage command.

As shown in FIG. 1, the excitation module 40 is electrically connected to the foregoing voltage output module 30. The excitation module 40 may be, for example, a direct current voltage generator. The excitation module 40 may selectively output a positive excitation voltage, a negative excitation voltage, and a zero voltage. The positive excitation voltage and the negative excitation voltage may be direct current voltages in opposite directions. The foregoing direct-axis voltage output unit 33 receives the positive excitation voltage or the negative excitation voltage and converts the positive excitation voltage or the negative excitation voltage to a positive direct-axis excitation voltage or a negative direct-axis excitation voltage. The direct-axis voltage output unit 33 may define a direct-axis voltage command according to the direct-axis pulse voltage versus the positive direct-axis excitation voltage, the direct-axis pulse voltage versus the negative direct-axis excitation voltage, and the direct-axis pulse voltage.

As shown in FIG. 1, in this embodiment, the voltage adjustment module 50 of the correction system 1 is electrically connected to the motor 10, the voltage output module 30, and the error calculation module 60. The voltage adjustment module 50 may be an inverter or a rectifier. The voltage adjustment module 50 may output a three-phase voltage to the stator 11 of the motor 10 by means of the Park's transformation, according to the direct-axis voltage command and the quadrature-axis voltage command defined by the voltage output module 30 and the synchronous angle ϕ calculated by the error calculation module 60.

As shown in FIG. 1, in this embodiment, a current conversion module 51 of the correction system 1 is electrically connected to the motor 10, the error calculation module 60, a direct-axis direct current extraction module 52, a quadrature-axis direct current extraction module 53 and a quadrature-axis pulse current extraction module 54. The current conversion module 51 may output a direct-axis current and a quadrature-axis current by means of the Park's transformation, according to the foregoing three-phase voltage and the foregoing synchronous angle ϕ. The direct-axis direct current extraction module 52 may extract a direct-axis direct current in the direct-axis current outputted by the current conversion module 51, the quadrature-axis direct current extraction module 53 may extract a quadrature-axis direct current in the quadrature-axis current outputted by the current conversion module 51, and the quadrature-axis pulse current extraction module 54 may extract a quadrature-axis high-frequency current in the quadrature-axis current outputted by the current conversion module 51.

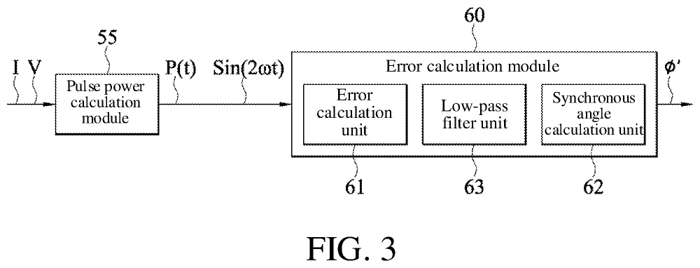

FIG. 3 is a schematic diagram of signal transmission between a pulse power calculation module and an error calculation module according to an embodiment of the instant disclosure. As shown in FIG. 1 to FIG. 3, in this embodiment, a pulse power calculation module 55 of the correction system 1 is electrically connected to the quadrature-axis pulse current extraction module 54 and the voltage output module 30. The pulse power calculation module 55 receives the foregoing quadrature-axis high-frequency current I and the pulse voltage V outputted by the pulse injection unit 31, and calculates an instantaneous pulse power P(t). The instantaneous pulse power P(t) may be calculated by multiplying the quadrature-axis high-frequency current I by the pulse voltage V. A physical expression of the instantaneous pulse power P(t) is:

$$P ( t ) = \frac{{V}_{a}^{2}}{ω ( {( \frac{{L}_{q} + {L}_{d}}{2} )}^{2} - {( \frac{{L}_{q} - {L}_{d}}{2} )}^{2} )} \times ( \frac{{L}_{q} - {L}_{d}}{4} ) \times sin ( θ ) \times sin ( 2 ω t ) ,$$

where P(t) is the instantaneous pulse power, Vₐ is the amplitude of the pulse voltage V, sin(2ωt) is a sine function of the pulse power, ω is an angular velocity of the pulse voltage V, L_{q} is a quadrature-axis inductance, L_{d} is a direct-axis inductance, θ is the angle difference, and tis the time.

As shown in FIG. 1 to FIG. 3, in this embodiment, the error calculation module 60 of the correction system 1 is electrically connected to the pulse power calculation module 55. The error calculation module 60 may include a low-pass filter unit 63, an error calculation unit 61, and a synchronous angle calculation unit 62. The error calculation unit 61 multiplies the instantaneous pulse power P(t) calculated by the pulse power calculation module 55 by a sine function sin(2ωt) of the pulse power to obtain a physical signal, and transmits the physical signal to the low-pass filter unit 63. The low-pass filter unit 63 performs noise reduction on the physical signal to obtain a pulse power with reduced noise. A physical expression of the pulse power with reduced noise is:

$$\overline{P} = LPF \{ p ( t ) \times sin ( 2 ω t ) \} \approx \frac{{v}_{a}^{2}}{ω ( {( \frac{{L}_{q} + {L}_{d}}{2} )}^{2} - {( \frac{{L}_{q} - {L}_{d}}{2} )}^{2} )} \times ( \frac{{L}_{d} - {L}_{q}}{8} ) \times sin ( θ ) ,$$

where P̅ is the pulse power with reduced noise, Vₐ is the amplitude of the pulse voltage V, sin(2ωt) is the sine function of the pulse power, ω is the angular velocity of the pulse voltage V, L_{q} is a quadrature-axis inductance, L_{d} is a direct-axis inductance, θ is the angle difference, t is the time, and LPF is a function for low-pass filtering, noise reduction, and noise filtering.

In addition, as shown in FIG. 1 to FIG. 3, the error calculation unit 61 may obtain an angle error gain by using known related parameters. A physical expression of the angle error gain is:

$$K = \frac{1}{\frac{{V}_{a}^{2}}{ω ( {( \frac{{L}_{q} + {L}_{d}}{2} )}^{2} - {( \frac{{L}_{q} - {L}_{d}}{2} )}^{2} )} \times ( \frac{{L}_{d} - {L}_{q}}{8} )} ,$$

where K is the angle error gain, Vₐ is the amplitude of the pulse voltage V, ω is the angular velocity of the pulse voltage V, L_{q} is the quadrature-axis inductance, and L_{d} is the direct-axis inductance.

As shown in FIG. 1 to FIG. 3, the error calculation unit 61 obtains the angle difference θ according to the pulse power with reduced noise and the synchronous angle error gain.

As shown in FIG. 1 to FIG. 3, the synchronous angle calculation unit 62 has an initial synchronous angle. The synchronous angle calculation unit 62 may adjust the synchronous angle ϕ according to the foregoing angle difference θ. For example, in this embodiment, the synchronous angle calculation unit 62 may be a phase-locked controller. The phase-locked controller adjusts the synchronous angle ϕ after obtaining the angle difference θ. An adjusted synchronous angle ϕ′ is equal to the synchronous angle ϕ plus the angle difference θ (as shown in FIG. 2).

As shown in FIG. 1, in this embodiment, the control module 70 is electrically connected to the storage module 20, the voltage output module 30, the error calculation module 60, the excitation module 40, the direct-axis direct current extraction module 52, the quadrature-axis direct current extraction module 53, and a magnetic pole position determination module 71. In some embodiments, the control module 70 may be a central processing unit (CPU) or other programmable microprocessors, a digital signal processor (DSP), a programmable controller, an application specific integrated circuits (ASIC), a programmable logic device (PLD), or other similar devices configured to control and coordinate operations of the units and the modules of the correction system 1 and responsible for data calculation and logical determination.

The magnetic pole position determination module 71 is configured to determine and store the north pole N of the magnetic pole direction M of the rotor 12. Determining the north pole N of the magnetic pole direction M of the rotor 12 is described later. In some embodiments, the magnetic pole position determination module 71 may also be integrated in the control module 70.

When the angle difference θ is zero, the control module 70 may be successively switched to a positive excitation mode, a positive de-excitation mode, a negative excitation mode, a negative de-excitation mode, and a magnetic pole correction mode to correct the motor rotor angle. Steps of a motor rotor angle correction method according to the embodiments of the instant disclosure are described below with reference to the drawings. For hardware structures mentioned below, refer to the correction system 1 disclosed in the foregoing embodiments of FIG. 1 and FIG. 2, which is not intended to limit the instant disclosure.

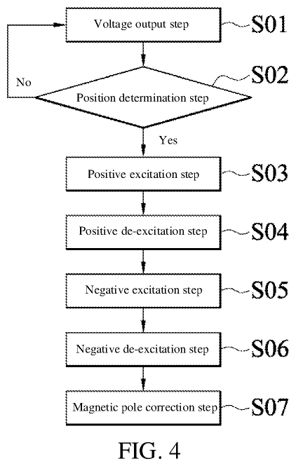

FIG. 4 is a flowchart of steps of the sensorless motor rotor angle correction method according to an embodiment of the instant disclosure. As shown in FIG. 4, a voltage output step S01 is first performed, including outputting a direct-axis pulse voltage to the stator 11 of the motor 10, so that the direct axis de of the synchronous rotation coordinate axis of the stator 11 generates a direct-axis current and the quadrature axis qe generates a quadrature-axis current. Referring to FIG. 1 to FIG. 2. In step S01, the correction system 1 continuously outputs the pulse voltage to the direct-axis voltage output unit 33 by using the pulse injection unit 31 of the voltage output module 30, continuously outputs the zero voltage to the direct-axis voltage output unit by using the quadrature-axis voltage output unit 32, and continuously outputs the zero voltage to the direct-axis voltage output unit 33 by using the excitation module 40, so that the direct-axis voltage output unit 33 of the voltage output module 30 outputs the direct-axis pulse voltage to the direct axis de of the stator 11 of the motor 10, and the quadrature-axis voltage output unit 32 of the voltage output module 30 outputs the zero voltage to the quadrature axis qe of the stator 11 of the motor 10. In this way, the direct axis de of the synchronous rotation coordinate axis of the stator 11 generates the direct-axis current and the quadrature axis qe generates the quadrature-axis current. In all of the embodiments of the instant disclosure, the quadrature-axis voltage output unit 32 outputs the zero voltage, so as to prevent the motor 10 from shaking during detection.

Next, as shown in FIG. 4, after the voltage output step S01, a position determination step S02 is performed, including determining whether the angle difference θ between the direct axis de and the magnetic pole direction M of the rotor 12 is zero, and performing a positive excitation step S03 when the angle difference θ is zero, or returning to the voltage output step S01 when the angle difference θ is not 0. Referring to FIG. 1 to FIG. 2, in step S02, the control module 70 of the correction system 1 determines whether the angle difference θ between the direct axis de and the magnetic pole direction M of the rotor 12 is zero by using the angle difference θ calculated by the error calculation module 60, and when the angle difference θ calculated by the error calculation module 60 received by the control module 70 is zero, the control module 70 is switched to the positive excitation mode, or when the angle difference θ calculated by the error calculation module 60 received by the control module 70 is not zero, the control module 70 is not switched to the positive excitation mode and continuously receives the angle difference θ calculated by the error calculation module 60.

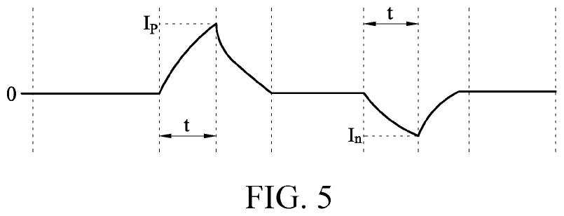

FIG. 5 is a schematic diagram of a direct-axis direct current according to an embodiment of the instant disclosure. Next, as shown in FIG. 4, after the position determination step S02, a positive excitation step S03 is performed, including outputting a positive direct-axis excitation voltage to the stator 11 when the angle difference θ is zero, and stopping outputting the positive direct-axis excitation voltage and recording an excitation time, when the direct-axis current reaches a predetermined positive current value from an initial current value. Referring to FIG. 1, FIG. 2, and FIG. 5, in step S03, the control module 70 is in the positive excitation mode, and the control module 70 controls the excitation module 40 to output a positive excitation voltage to the direct-axis voltage output unit 33, so that the direct-axis voltage output unit 33 of the voltage output module 30 outputs a positive direct-axis excitation voltage to the direct-axis de of the stator 11 of the motor 10. Under the action of the positive direct-axis excitation voltage, the direct-axis current of the direct-axis de of the stator 11 rises from an initial current value. When the direct-axis current reaches a predetermined positive current value Iₚ pre-stored in the storage module 20, the control module 70 controls the excitation module 40 to stop outputting the positive direct-axis excitation voltage and controls the storage module 20 to store an excitation time t spent for reaching the predetermined positive current value Iₚ from the initial current value. The initial current value may be zero, and the excitation time is usually 2.5 milliseconds.

Next, as shown in FIG. 4, after the positive excitation step S03, a positive de-excitation step S04 is performed, including outputting a negative direct-axis excitation voltage to the stator 11, so that the direct-axis current returns to the initial current value from the predetermined positive current value. Referring to FIG. 1, FIG. 2, and FIG. 5, in step S04, the control module 70 of the correction system 1 is switched to the positive de-excitation mode, and the control module 70 controls the excitation module 40 to output a negative excitation voltage to the direct-axis voltage output unit 33, so that the direct-axis voltage output unit 33 outputs a negative direct-axis excitation voltage to the direct axis de of the stator 11 of the motor 10, and the direct-axis current returns to the initial current value from the predetermined positive current value Iₚ.

Next, as shown in FIG. 4, after the positive de-excitation step S04, a negative excitation step S05 is performed, including stopping outputting the negative direct-axis excitation voltage and obtaining a maximum negative current value, when the negative direct-axis excitation voltage is outputted to the stator 11 for the excitation time. Referring to FIG. 1, FIG. 2, and FIG. 5, in step S05, the control module 70 is switched to the negative excitation mode, and the control module 70 controls the excitation module 40 to output a negative excitation voltage to the direct-axis voltage output unit 33, so that the direct-axis voltage output unit 33 outputs a negative direct-axis excitation voltage to the direct-axis de of the stator 11 of the motor 10. Under the action of the negative direct-axis excitation voltage, the direct-axis current of the direct-axis de of the stator 11 decreases from the initial current value. When the excitation module 40 outputs the negative excitation voltage for the excitation time t stored in the storage module 20, the control module 70 controls the excitation module 40 to stop outputting the negative direct-axis excitation voltage. The control module 70 receives a direct-axis direct current obtained by the direct-axis direct current extraction module 52 during the excitation time t, and obtains a maximum negative current value Iₙ from the direct-axis direct current, and the control module 70 controls the storage module 20 to store the maximum negative current value Iₙ.

Next, as shown in FIG. 4, after the negative excitation step S05, a negative de-excitation step S06 is performed, including outputting the positive direct-axis excitation voltage to the stator 11, so that the direct-axis current returns to the initial current value from the maximum negative current value. Referring to FIG. 1, FIG. 2, and FIG. 5, in step S06, the control module 70 is switched to the negative de-excitation mode, and the control module 70 controls the excitation module 40 to output a positive excitation voltage to the direct-axis voltage output unit 33, so that the direct-axis voltage output unit 33 of the voltage output module 30 outputs a positive direct-axis excitation voltage to the direct-axis de of the stator 11 of the motor 10. Therefore, a flowing direction of the direct-axis current is changed from negative to positive, so that the direct-axis current returns to the initial current value from the foregoing maximum negative current value Iₙ.

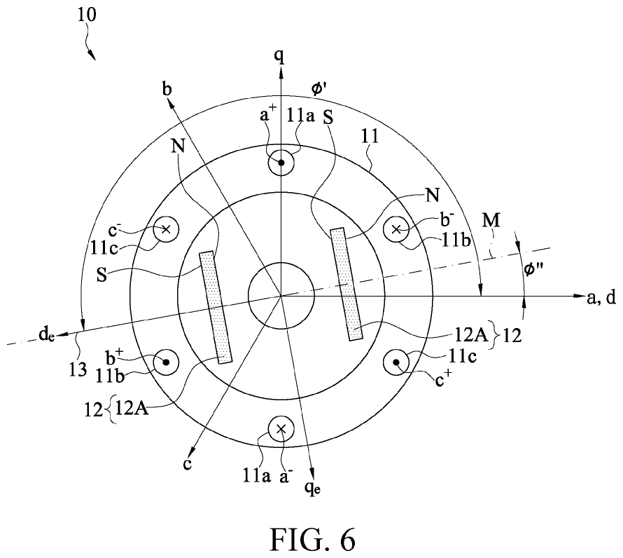

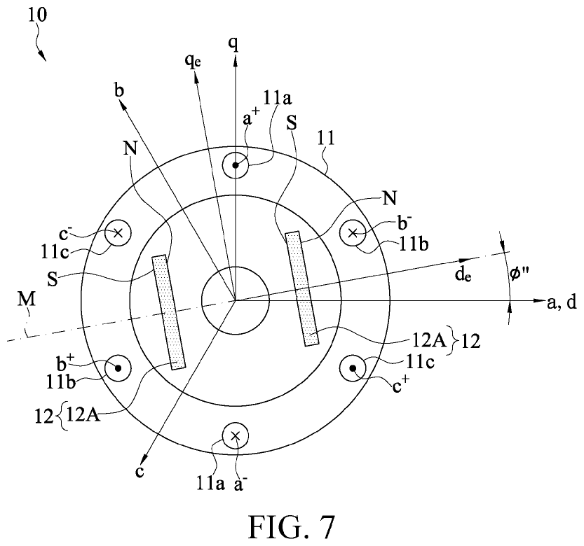

FIG. 6 is a cross-sectional view of other relative positions of the rotor and the stator according to an embodiment of the instant disclosure, and FIG. 7 is a cross-sectional view of still other relative positions of the rotor and the stator according to an embodiment of the instant disclosure. Finally, as shown in FIG. 4, after the negative de-excitation step S06, a magnetic pole correction step S07 is performed, including correcting an orientation of the synchronous rotation coordinate axis if the maximum negative current value Iₙ is greater than the predetermined positive current value Iₚ (with reference to FIG. 5), so that the direct axis de is oriented toward a north pole N of the magnetic pole direction M. Referring to FIG. 1, FIG. 2, and FIG. 5 to FIG. 7, in step S06, the control module 70 of the correction system 1 is switched to the magnetic pole correction mode. In the magnetic pole correction mode, the control module 70 determines whether the maximum negative current value Iₙ is greater than the predetermined positive current value Iₚ by using the magnetic pole position determination module 71. When the maximum negative current value Iₙ is greater than the predetermined positive current value Iₚ, it means that the direct axis de is oriented toward a south pole S of the magnetic pole direction M (shown in FIG. 6). In this case, the control module 70 corrects the synchronous angle ϕ′ of the error calculation module 60. A corrected synchronous angle ϕ″ may be the foregoing adjusted synchronous angle ϕ′ plus 180°. The voltage adjustment module 50 corrects the orientation of the synchronous rotation coordinate axis according to the foregoing corrected synchronous angle ϕ″, so that the direct axis de is oriented toward the north N of the magnetic pole direction M (shown in FIG. 7).

In summary, according to the sensorless motor rotor angle correction method and system in the embodiments of the instant disclosure, the direct-axis pulse voltage is outputted to the stator 11 of the motor 10, so that the direct axis de of the synchronous rotation coordinate axis of the stator 11 generates the direct-axis current and the quadrature axis qe generates the quadrature-axis current, and when the angle difference θ between the direct axis de and the magnetic pole direction M of the rotor 12 is zero, the positive excitation step S03, the positive de-excitation step S04, the negative excitation step S05, the negative de-excitation step S06, and the magnetic pole correction step S07 are performed, to determine whether the orientation of the synchronous rotation coordinate axis needs to be corrected, so that relative positions of the rotor 12 and the stator 11 of the motor 10 can be detected and corrected at any time at any speed without a need to mount a sensor on the motor 10, thereby ensuring that the rotor 12 and the stator 11 are synchronous.

In addition, according to the sensorless motor rotor angle correction method and system in embodiments of the instant disclosure, by using the positive de-excitation step S04, the direct-axis current can quickly return to the initial current value from the predetermined positive current value Iₚ, to reduce a time required for the correction. Similarly, according to the sensorless motor rotor angle correction method and system in the embodiments of the instant disclosure, by using the negative de-excitation step S06, the direct-axis current can quickly return to the initial current value from the maximum negative current value Iₙ, to reduce the time required for the correction.

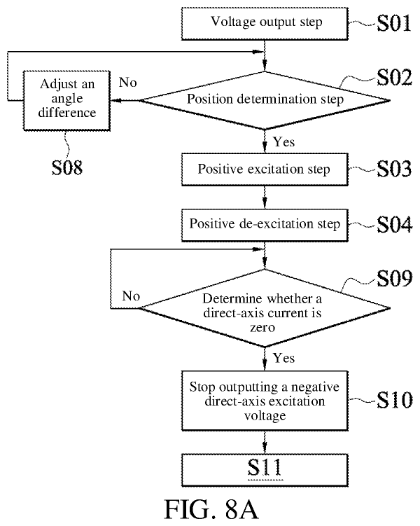

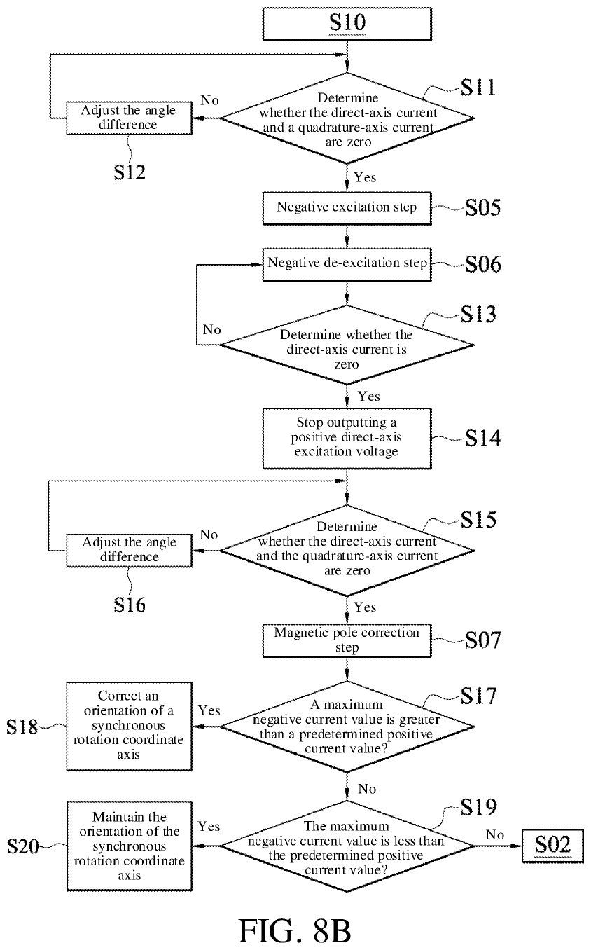

FIG. 8A is a partial flowchart of steps of a sensorless motor rotor angle correction method according to another embodiment of the instant disclosure. FIG. 8B is another partial flowchart of the steps of the sensorless motor rotor angle correction method according to an embodiment of the instant disclosure. FIG. 8A and FIG. 8B together are a complete flowchart of another embodiment. As shown in FIG. 8A and FIG. 8B, there are many differences between this embodiment and the previous embodiment, which are described below with reference to the drawings. For hardware structures mentioned below, refer to the correction system 1 disclosed in the foregoing embodiments of FIG. 1 and FIG. 2, which is not intended to limit the instant disclosure. As shown in FIG. 8A and FIG. 8B, compared with the previous embodiment, in this embodiment, the position determination step S02 further includes determining whether the direct-axis current and the quadrature-axis current are zero, and adjusting the angle difference θ if the direct-axis current and the quadrature-axis current are not zero (step S08), so that the direct-axis current and the quadrature-axis current are zero. Referring to FIG. 1 and FIG. 2, in step S02, the control module 70 of the correction system 1 determines whether the direct-axis current and the quadrature-axis current are zero by using the direct-axis direct current extraction module 52 and the quadrature-axis direct current extraction module 53, and if the direct-axis current and the quadrature-axis current are not zero, the voltage adjustment module 50 may adjust, to zero, the angle difference θ calculated by the error calculation module 60, and then adjust the synchronous angle ϕ, so that the direct-axis current and the quadrature-axis current are zero. The positive excitation step S03 is performed only when the direct-axis current and the quadrature-axis current are zero. In this way, the position determination step S02 only needs to determine whether the direct-axis current and the quadrature-axis current are zero to determine whether the angle difference θ needs to be adjusted, so that the correction system 1 can quickly obtain information to reduce the time required for the correction.

As shown in FIG. 8A and FIG. 8B, compared with the previous embodiment, in this embodiment, after the negative de-excitation step S06, the method further includes determining whether the direct-axis current is zero (step S13), and stop outputting the positive direct-axis excitation voltage if the direct-axis current is zero (step S14). Referring to FIG. 1 and FIG. 2, in step S13, in the negative de-excitation mode, the control module 70 of the correction system 1 further determines whether the direct-axis current is zero by using the direct-axis direct current extraction module 52, and if the direct-axis current is zero, the control module 70 controls the excitation module 40 to stop outputting the positive direct-axis excitation voltage. In this way, accuracy of the correction of the correction system 1 is ensured.

As shown in FIG. 8A and FIG. 8B, compared with the previous embodiment, in this embodiment, after the positive de-excitation step S04, the method further includes determining whether the direct-axis current is zero (step S09), and adjusting the negative direct-axis excitation voltage if the direct-axis current is not zero, so that the direct-axis current is zero. Referring to FIG. 1 and FIG. 2, in step S09, in the positive de-excitation mode, the control module 70 of the correction system 1 further determines whether the direct-axis current is not zero by using the direct-axis direct current extraction module 52, and if the direct-axis current is zero, the control module 70 controls the excitation module 40 to adjust the negative direct-axis excitation voltage, so that the direct-axis current is zero.

In addition, as shown in FIG. 8A and FIG. 8B, in this embodiment, after step S09 is performed, if it is determined that the direct-axis current is zero, stopping outputting the negative direct-axis excitation voltage (step S10). Referring to FIG. 1, FIG. 2, and FIG. 5, in step S10, in the positive de-excitation mode, when the control module 70 of the correction system 1 determines that the direct-axis current is zero by using the direct-axis direct current extraction module 52, the control module 70 further controls the excitation module 40 to stop outputting the negative direct-axis excitation voltage. In this way, accuracy of the maximum negative current value Iₙ obtained subsequently is ensured, thereby ensuring the accuracy of the correction of the correction system 1.

In addition, as shown in FIG. 8A and FIG. 8B, in this embodiment, after the positive de-excitation step S04, the method further includes step S10 of determining whether the direct-axis current and the quadrature-axis current are zero (step S11). Referring to FIG. 1 and FIG. 2, in step S11, in the positive de-excitation mode, after the excitation module 40 stops outputting the negative direct-axis excitation voltage, the control module 70 of the correction system 1 further determines whether the direct-axis current and the quadrature-axis current are zero by using the direct-axis direct current extraction module 52 and the quadrature-axis direct current extraction module 53. In this way, only whether the direct-axis current and the quadrature-axis current are zero needs to be determined to determine whether the angle difference θ needs to be adjusted, so that the correction system 1 can quickly obtain information to reduce the time required for the correction.

In addition, as shown in FIG. 8A and FIG. 8B, after step S11 is performed, if the direct-axis current and the quadrature-axis current are not zero, adjusting the angle difference θ (step S12), including adjusting the direct-axis current and the quadrature-axis current according to the angle difference θ, so that the direct-axis current and the quadrature-axis current are zero. Referring to FIG. 1 and FIG. 2, in step S12, when the control module 70 determines that the direct-axis current or the quadrature-axis current is not zero by using the direct-axis direct current extraction module 52 and the quadrature-axis direct current extraction module 53, the voltage adjustment module 50 adjusts the angle difference θ and the synchronous angle ϕ, so that the direct-axis current and the quadrature-axis current are zero. In this way, the accuracy of the maximum negative current value Iₙ obtained subsequently is ensured, thereby ensuring the accuracy of the correction of the correction system 1.

As shown in FIG. 8A and FIG. 8B, in this embodiment, after step S14, the method further includes determining whether the direct-axis current and the quadrature-axis current are zero (step S15), and performing the magnetic pole correction step S07 if the direct-axis current and the quadrature-axis current are zero, or adjusting the angle difference if the direct-axis current and the quadrature-axis current are not zero (step S16). Referring to FIG. 1 and FIG. 2, in step S15, in the negative de-excitation mode, the control module 70 of the correction system 1 further determines whether the direct-axis current and the quadrature-axis current are zero by using the direct-axis direct current extraction module 52 and the quadrature-axis direct current extraction module 53. When it is determined that the direct-axis current and the quadrature-axis current are zero, the control module 70 is switched to the magnetic pole correction mode. In step S16, when it is determined that the direct-axis current or the quadrature-axis current is not zero, the voltage adjustment module 50 adjusts the angle difference θ and the synchronous angle ϕ, so that the direct-axis current and the quadrature-axis current are zero.

As shown in FIG. 8A and FIG. 8B, compared with the previous embodiment, in this embodiment, after the magnetic pole correction step S07, the method further includes determining whether the maximum negative current value is greater than the predetermined positive current value (step S17), and correcting the orientation of the synchronous rotation coordinate axis if the maximum negative current value is greater than the predetermined positive current value (step S18). In this embodiment, after step S17, the method further includes determining whether the maximum negative current value is less than the predetermined positive current value if the maximum negative current value is not greater than the predetermined positive current value (step S19), and maintaining the orientation of the synchronous rotation coordinate axis if the maximum negative current value is less than the predetermined positive current value (step S20). Referring to FIG. 1, FIG. 2, and FIG. 5 to FIG. 7, instep S17, when the control module 70 of the correction system 1 determines that the maximum negative current value Iₙ is greater than the predetermined positive current value Iₚ, it means that the direct axis de is oriented toward the south pole S of the magnetic pole direction M. Therefore, in step S18, the voltage adjustment module 50 needs to correct the orientation of the synchronous rotation coordinate axis 13 according to the foregoing corrected synchronous angle ϕ″, so that the direct axis de is oriented toward the north pole N of the magnetic pole direction M. In step S19, when the control module 70 determines that the maximum negative current value Iₙ is less than the predetermined positive current value Iₚ, it means that the direct axis de is oriented toward the north pole N of the magnetic pole direction M. Therefore, in step S20, the voltage adjustment module 50 does not need to correct the synchronous angle ϕ′ of the error calculation module 60, and the voltage adjustment module 50 maintains the orientation of the synchronous rotation coordinate axis according to the adjusted synchronous angle ϕ′.

As shown in FIG. 8A and FIG. 8B, after step S19, if the maximum negative current value is not less than the predetermined positive current value, that is, the maximum negative current value is equal to the predetermined positive current value, the position determination step S02 is re-performed. Referring to FIG. 1, FIG. 2, FIG. 5, and FIG. 7, in step S19, in the magnetic pole correction mode, when the control module 70 of the correction system 1 determines that the maximum negative current value is equal to the predetermined positive current value Iₚ, which means that the direct axis de is oriented toward neither the north pole N nor the south pole S of the magnetic pole direction M, the control module 70 further performs determination on the angle difference θ. When the angle difference θ is zero, the control module 70 is successively switched to the positive excitation mode, the positive de-excitation mode, the negative excitation mode, the negative de-excitation mode, and the magnetic pole correction mode to detect whether the correction system 1 is faulty.

What is claimed is:

1. A sensorless motor rotor angle correction method, comprising:
a voltage output step comprising outputting a direct-axis pulse voltage to a stator of a motor, so that a direct axis of a synchronous rotation coordinate axis of the stator generates a direct-axis current, and a quadrature axis of the synchronous rotation coordinate axis generates a quadrature-axis current;
a position determination step comprising determining whether an angle difference between the direct axis and a magnetic pole direction of a rotor is zero;
a positive excitation step comprising outputting a positive direct-axis excitation voltage to the stator when the angle difference is zero, and stopping outputting the positive direct-axis excitation voltage and recording an excitation time, when the direct-axis current reaches a predetermined positive current value from an initial current value;
a positive de-excitation step comprising outputting a negative direct-axis excitation voltage to the stator, so that the direct-axis current returns to the initial current value from the predetermined positive current value;
a negative excitation step comprising stopping outputting the negative direct-axis excitation voltage and obtaining a maximum negative current value, when the negative direct-axis excitation voltage is outputted to the stator for the excitation time;
a negative de-excitation step comprising outputting the positive direct-axis excitation voltage to the stator, so that the direct-axis current returns to the initial current value from the maximum negative current value; and
a magnetic pole correction step comprising correcting an orientation of the synchronous rotation coordinate axis if the maximum negative current value is greater than the predetermined positive current value, so that the direct axis is oriented toward a north pole of the magnetic pole direction.

2. The sensorless motor rotor angle correction method according to claim 1, wherein the position determination step further comprises determining whether the direct-axis current and the quadrature-axis current are zero, and adjusting the angle difference if the direct-axis current and the quadrature-axis current are not zero, so that the direct-axis current and the quadrature-axis current are zero.

3. The sensorless motor rotor angle correction method according to claim 1, wherein the predetermined positive current value is greater than 50% of a rated current value of the motor.

4. The sensorless motor rotor angle correction method according to claim 2, wherein after the negative de-excitation step, the method further comprises determining whether the direct-axis current is zero, and stopping outputting the positive direct-axis excitation voltage if the direct-axis current is zero.

5. The sensorless motor rotor angle correction method according to claim 2, wherein after the positive de-excitation step, the method further comprises determining whether the direct-axis current is zero, and adjusting the negative direct-axis excitation voltage if the direct-axis current is not zero, so that the direct-axis current is zero.

6. The sensorless motor rotor angle correction method according to claim 5, wherein after the positive de-excitation step, the method further comprises stopping outputting the negative direct-axis excitation voltage when it is determined that the direct-axis current is zero.

7. The sensorless motor rotor angle correction method according to claim 6, wherein after the positive de-excitation step, the method further comprises after stopping outputting the negative direct-axis excitation voltage, determining whether the direct-axis current and the quadrature-axis current are zero.

8. The sensorless motor rotor angle correction method according to claim 7, wherein if the direct-axis current and the quadrature-axis current are not zero, the direct-axis current and the quadrature-axis current are adjusted according to the angle difference, so that the direct-axis current and the quadrature-axis current are zero.

9. The sensorless motor rotor angle correction method according to claim 1, wherein after the magnetic pole correction step, the method further comprises maintaining the orientation of the synchronous rotation coordinate axis if the maximum negative current value is less than the predetermined positive current value.

10. The sensorless motor rotor angle correction method according to claim 1, wherein after the magnetic pole correction step, the method further comprises re-performing the position determination step if the maximum negative current value is equal to the predetermined positive current value.

11. A sensorless motor rotor angle correction system, comprising:
a motor, comprising a stator and a rotor, wherein the stator has a synchronous rotation coordinate axis having a direct axis and a quadrature axis, and the rotor has a magnetic pole direction;
a storage module, configured to store a predetermined positive current value;
a voltage output module, configured to output a direct-axis pulse voltage to the stator, so that the direct axis generates a direct-axis current and the quadrature axis generates a quadrature-axis current;
an excitation module, configured to output a positive direct-axis excitation voltage or a negative direct-axis excitation voltage to the stator;
an error calculation module, configured to calculate an angle difference between the direct axis and the magnetic pole direction;
a voltage adjustment module electrically connected to the motor, the voltage output module, and the error calculation module; and
a control module, electrically connected to the motor, the storage module, the voltage output module, the error calculation module, the excitation module, and the voltage adjustment module, wherein the control module is configured to be successively switched to a positive excitation mode, a positive de-excitation mode, a negative excitation mode, a negative de-excitation mode, and a magnetic pole correction mode when the angle difference is zero, wherein
in the positive excitation mode, the control module controls the excitation module to output the positive direct-axis excitation voltage, and when the direct-axis current reaches the predetermined positive current value from an initial current value, the control module controls the excitation module to stop outputting the positive direct-axis excitation voltage and controls the storage module to store an excitation time;
in the positive de-excitation mode, the control module controls the excitation module to output the negative direct-axis excitation voltage to the stator, so that the direct-axis current returns to the initial current value from the predetermined positive current value;
in the negative excitation mode, when the control module controls the excitation module to output the negative direct-axis excitation voltage to the stator for the excitation time, the control module controls the excitation module to stop outputting the negative direct-axis excitation voltage, and obtains a maximum negative current value and controls the storage module to store the maximum negative current value;
in the negative de-excitation mode, the control module controls the excitation module to output the positive direct-axis excitation voltage to the stator, so that the direct-axis current returns to the initial current value from the maximum negative current value; and
in the magnetic pole correction mode, when the control module determines that the maximum negative current value is greater than the predetermined positive current value, the voltage adjustment module corrects an orientation of the synchronous rotation coordinate axis, so that the direct axis is oriented toward a north pole of the magnetic pole direction.

12. The sensorless motor rotor angle correction system according to claim 11, the control module determines whether the angle difference is zero according to whether the direct-axis current and the quadrature-axis current are zero, and if the direct-axis current and the quadrature-axis current are not zero, the voltage adjustment module adjusts the angle difference, so that the direct-axis current and the quadrature-axis current are zero.

13. The sensorless motor rotor angle correction system according to claim 11, wherein the predetermined positive current value is greater than 50% of a rated current value of the motor.

14. The sensorless motor rotor angle correction system according to claim 12, wherein the negative de-excitation mode further comprises determining, by the control module, whether the direct-axis current is zero, and controlling, by the control module, the excitation module to stop outputting the positive direct-axis excitation voltage if the direct-axis current is zero.

15. The sensorless motor rotor angle correction system according to claim 12, wherein the positive de-excitation mode further comprises determining, by the control module, whether the direct-axis current is zero, and controlling, by the control module, the excitation module to adjust the negative direct-axis excitation voltage if the direct-axis is not zero, so that the direct-axis current is zero.

16. The sensorless motor rotor angle correction system according to claim 15, wherein the positive de-excitation mode further comprises controlling, by the control module, the excitation module to stop outputting the negative direct-axis excitation voltage when the control module determines that the direct-axis current is zero.

17. The sensorless motor rotor angle correction system according to claim 16, wherein the positive de-excitation mode further comprises: after the excitation module stops outputting the negative direct-axis excitation voltage, determining, by the control module, whether the direct-axis current and the quadrature-axis current are zero.

18. The sensorless motor rotor angle correction system according to claim 17, wherein if the direct-axis current and the quadrature-axis current are not zero, the voltage adjustment module adjusts the direct-axis current and the quadrature-axis current according to the angle difference, so that the direct-axis current and the quadrature-axis current are zero.

19. The sensorless motor rotor angle correction system according to claim 11, wherein the magnetic pole correction mode further comprises maintaining, by the voltage adjustment module, the orientation of the synchronous rotation coordinate axis if the control module determines that the maximum negative current value is less than the predetermined positive current value.

20. The sensorless motor rotor angle correction system according to claim 11, wherein the magnetic pole correction mode further comprises successively re-switching the control module to the positive excitation mode, the positive de-excitation mode, the negative excitation mode, the negative de-excitation mode, and the magnetic pole correction mode if the control module determines that the maximum negative current value is equal to the predetermined positive current value.
